(19) United States
(12) Patent Application Publication
(10) Pub. No.: US 2015/0288644 A1
(43) Pub. Date: Oct. 8, 2015

(54) Intermediary Messaging System For Online Dating And Social Networking Websites

(71) Applicant: Antoine El Daher, Kenmore, WA (US)

(72) Inventor: Antoine El Daher, Kenmore, WA (US)

(21) Appl. No.: 14/246,127

(22) Filed: Apr. 6, 2014

(51) Int. Cl. H04L 12/58

(52) U.S. Cl. CPC H04L 51/32

(57) ABSTRACT

A method for allowing users on social networking websites, online dating websites, business networking websites, or other profile-based websites to request critiques for their messages before they are sent to their intended recipients. In its main embodiment, a user A writes a message to a second user B and requests that the message reviewed by someone before being delivered to user B. The website server then locates a third user C, who is very similar to user B and who is willing to read and review the message. If C approves of the message, it is sent to user B—otherwise it is returned to user A with feedback. Other embodiments include the possibility for user C to be rewarded for doing the reviewing work, as well as options for users A, B and C to all be anonymized. Selection of user C can also be restricted to make sure that C and B are very far from each other geographically, or in unrelated industries.

### BACKGROUND

### Prior Art

The following is a tabulation of some prior art that presently appears relevant to this application:

### U.S. Patents and Applications

| Patent Number | Issue/Publication Date | First Patentee or Assignee |
|---|---|---|
| 6,480,885 | Nov. 12, 2002 | Michael Olivier |
| 7,454,357 | Nov. 18, 2008 | Eharmony, Inc. |
| 7,669,123 | Aug. 11, 2006 | Facebook, Inc. |
| 7,725,492 | May 25, 2006 | Facebook, Inc. |
| 7,917,448 | Mar. 29, 2011 | Yahoo! Inc. |
| 8,060,463 | Nov. 15, 2011 | Amazon Technologies, Inc. |
| 8,566,327 | Oct. 22, 2013 | Choi |
| 8,583,563 | Nov. 12, 2013 | Carrico |
| 20050021750 | Jan. 27, 2005 | Friendster Inc., A California |
| | | Corporation |
| 20060059147 | Mar. 16, 2006 | Yahoo! Inc. |
| 20060085419 | Apr. 20, 2006 | Rosen James S |
| 20060106780 | May 18, 2006 | Ofer Dagan |
| 20060173963 | Aug. 3, 2006 | Microsoft Corporation |
| 20070073687 | Mar. 29, 2007 | Match.Com, L.P. |
| 20070073803 | Mar. 7, 2007 | Match.Com, L.P. |
| 20070192106 | Aug. 16, 2007 | Signal Match Inc. |
| 20080294624 | Nov. 27, 2008 | Ontogenix, Inc. |
| 20080301118 | Dec. 4, 2008 | Shu-Yao Chien |
| 20090106043 | Apr. 23, 2009 | Eharmony, Inc. |
| 20100293476 | Nov. 18, 2010 | Radius Dating LLC |
| 14/244,904 | N/A | El Daher |

### Non-Patent Literature

Analysis of user keyword similarity in online social networks—Bhattacharyya et al., Jun. 3, 2010

Over the past few years, the Internet has seen a rise in the number of websites available. One type of such websites are online dating and social networking websites. These websites are designed to allow human users to post information about themselves, in what is called a profile. The profile typically contains one or more traits that the user has. Such traits include but are not limited to: age, gender, pictures of the user, and possibly profession, work experience and physical address. We interchangeably refer to those user traits hereafter as characteristics or properties. Those profiles can serve a variety of purposes: in online dating, the profiles give other users of the website a general idea of what the user looks like and allows those other people to decide whether they think the user would be a good romantic match for them. In social networking, the profile is put up to allow friends and family to see it, and let them keep in touch with the user through e-mail, messaging, or other means. In business online networks, the profile can serve as a resume to allow other professionals, recruiters or companies to evaluate the user and potentially consider him as a candidate for a job opening.

In nearly all of the situations described above, the human user creates a page that he believes will best portray him in the online community that he joined, and allow him to achieve certain goals: for example, finding a romantic partner in online dating, getting a job offer in business networks, and so on. There are several other situations where websites are advertising users' profiles, and several websites where the users are the main product of the website. With the rise of social networking, these websites are becoming more and more dominant.

One issue that a lot of users seem to suffer from is crafting well targeted and interesting messages when trying to communicate with another user of the website who they have not or rarely interacted with. This is particularly prevalent in online dating and in business networking, where a lack of experience can result in the user sending subpar messages to their target.

In many of these cases, a user trying to message a second user, can benefit from having a third user, who is similar to the second user, review the message before it is sent.

We use the words critique, feedback and reviews interchangeably throughout the text to mean the act of one user C looking at a second user A's message, and C giving user A information about how C believes that A can improve his message to better help him reach his target audience. A critique can be numeric such as a grading system associated with a question, textual or both. For example, a piece of critique information on a business site that user C could give about user A's message, could be: “Your message is good but a little unoriginal—try talking more about why you think you're a good fit for this job”.

We will also be referring to social networking website below but the method applies to all kinds of websites where it is possible for a user to message another user from within the website.

We use the word website to denote the set of all links contained within the same internet web domain. For example foo.com is a website associated with the URL http://foo.com/user1 or with URL http://mail.foo.com/otherlink/somethingelse.

### SUMMARY

This summary is meant to introduce a few concepts in a simplified form that are further described below in the Detailed Description. It is not intended to identify key features or essential features of the claimed subject matter, nor is it intended to be used as an aid in determining the scope of the claimed subject matter.

The premise of this application is that for social networking websites, online dating sites, business networking websites, it would be useful if there was a simple way to get a message from user A to user B reviewed by a user C who is similar to user B, before it was delivered to user B's inbox.

One embodiment for solving this problem follows: we propose a method by which a user can request feedback about his message before it is delivered to its target recipient, by another user who is similar to the target recipient.

We describe several other embodiments in the detailed description and claims.

### ADVANTAGES

The advantages of such a system is that it allows users to avoid common pitfalls when sending message to people that they are not used sending to, while getting more experienced individuals to review them.

### DRAWINGS

FIG. 1 is a flow diagram that illustrates what typically happens on a social networking website when a user wants to message another user.

FIG. 2 shows a first proposed embodiment, where a third similar user is introduced to help review the message.

FIG. 3 shows a second proposed embodiment, where the third user is rewarded for his help in writing the message.

FIG. 4 describes a basic social networking architecture as they are currently available on the market.

FIG. 5A shows part of the contents of one of the terminals used in FIG. 4.

FIG. 5B shows part of the contents of one of the servers used in FIG. 4.

### DETAILED DESCRIPTION

### First Embodiment

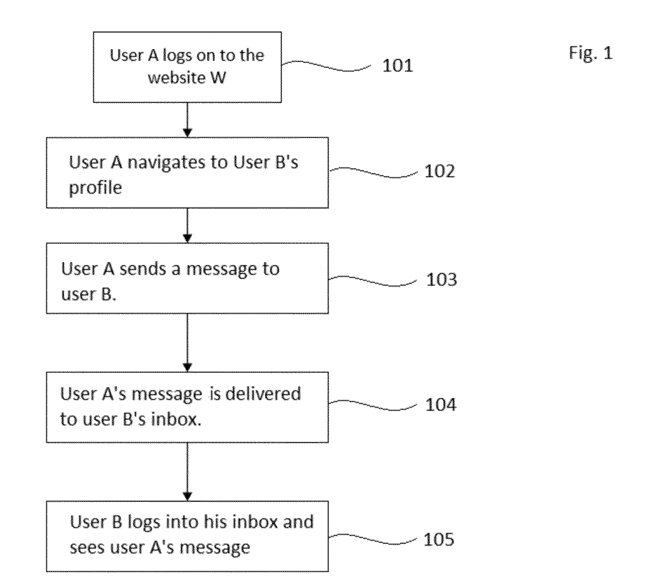

FIG. 1 shows the typical flow followed by a user when sending a message within a website.

In the first step 101, user A logs into the website under consideration W. This can be a social networking website, an online dating website, a business networking website, or any other website where users can communicate with other users from within the website.

User A then visits User B′s profile as shown in 102. This is a task that is common in today's websites.

User A then writes and sends a message M to user B using the website W's interface as shown in 103. The message is stored in W's server database or it can be stored in an external database, and user B may be at this time notified that a message has arrived in his inbox. In some websites, it is also possible for user B not to be notified of the arrival of a message. Either way the message M is now delivered into user B's inbox as in 104.

User B then logs into his inbox using the website and sees a message is waiting for him, as shown in 105. He may then choose to open and read that message.

This flow is the well-known flow used by many websites that are currently in existence. They allow direct messaging from one user to another without any intermediate review.

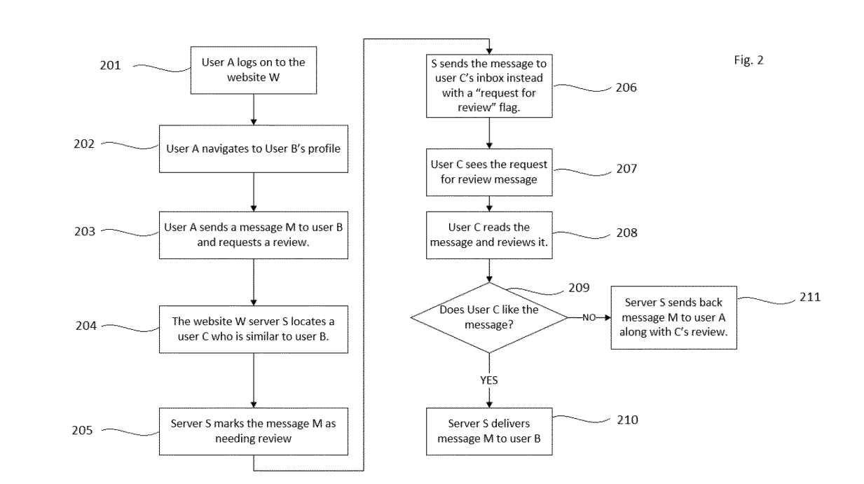

FIG. 2 shows the first proposed embodiment of our method.

As before, the user A first logs into the website W as shown in 201, then navigates to user B's profile as shown in 202. At that point, user A decides to send a message to user B.

After writing and entering the message, user A may be prompted whether he would like someone to review said message before it is actually delivered to user B, as shown in 203. If the user declines, then the message is immediately delivered to user B's inbox as was done in FIG. 1. If the user accepts and requests a review, the flow goes to 204.

In 204, the server has available to it: who the sending user is (user A), who the receiving user is (user B), and what the message is (message M). By looking through its database, the server attempts to locate a user C who is similar to user B. In the main embodiment, any such user C will do but in another embodiment, only users meeting certain criteria and who have not opted out of reviewing messages can be considered. By similar, we mean: within the same age range, or in the same industry, or same gender, or with similar descriptions about themselves. By similar description we refer to any of the techniques that are currently available for comparing the similarity between two documents. A similarity score is computed based on the above factors—the means of calculating said similarity scores are well documented in the literature. We've referenced one such published paper that's used to compute user similarity by Bhattacharyya in the non-patent literature section above, but the techniques are explained in other books and papers that have been published.

Once a user C who's similar to user B has been located, the server S modifies the message M to make it clear that this message is intended for someone else (user B) and that it is being sent to user C in order to get reviews, as shown in 205. There are several ways to modify the message but one simple option could be to add the following header: “User A would like your feedback on this message that he is sending to user B”, and then additionally include a link to user A's profile, user B's profile and the message itself. There are many other variants and sentences that can be used to achieve this. It is then delivered to user C's inbox instead of user B's inbox as shown in 206. At this point, user C is notified by electronic mail or messaging that a message is pending his review. In another embodiment, user C would not be notified.

At a later point in time, user C logs into the website and views the request to review a message, as shown in 207. That review request includes user A's profile, user B's profile as well as the message content. In some embodiments, user A and user B's profiles have both been stripped of any identifying information such as name, pictures, addresses, or user IDs. In other embodiments, only user B's profile has been anonymized, and in other embodiments none of the users have been anonymized.

User C may then choose to read the message and review it (208), or he may ignore it entirely. If user C does choose to review it, then he will rate the quality of the message on a score scale, and optionally give additional text feedback about how to improve the message. The score scale can be similar to a star-rating system (i.e. one to five stars), or a simple yes/no grade, as well as any of the equivalent well-known ways to grade scores. The feedback that user C gives is intended to attempt to improve the quality of message M, and since user C is selected so that he is similar to user B, he may have more insight as to how to improve said message.

At this point, user C knows whether he finds the message acceptable (209) and whether he subjectively believes that user B will like the message. If he believes that user B will like message (210), then by marking it as acceptable or scoring it highly, the server understands that this is a message that can now be forwarded to user B with no further modifications. In another embodiment, user A may request that the message not be forwarded to user B even if user C found it acceptable, in which case the flow would continue to step 211.

If user C did not like the message sent by user A, as is the case in 211, the server will send back a notification to user A along with the feedback given by user C, and will not forward message M to user B.

To summarize the above flow, user C acts as a gatekeeper for user B's inbox and user A's reputation by ensuring that only messages that he believes are of high quality make it through from user A to user B.

In the context of professional business networking for example, let's say user A has recently graduated college and has only two years of work experience. User A wants to contact the CEO of a company and crafts his own message. He can then request that somebody in a similar position to that CEO review his message before it is sent, to improve his chances of getting said CEO's attention.

In the context of online dating for example, let's say user A is trying to find a romantic partner on website W. User A has messaged a few other users, but has received little to no interest. User A can then request his message to be reviewed by another user C before it reaches his intended recipient user B, so that user C can notify him of anything blatantly wrong with his message. The server would then be responsible for automatically finding a user which is suitable to give such feedback, in this case user C.

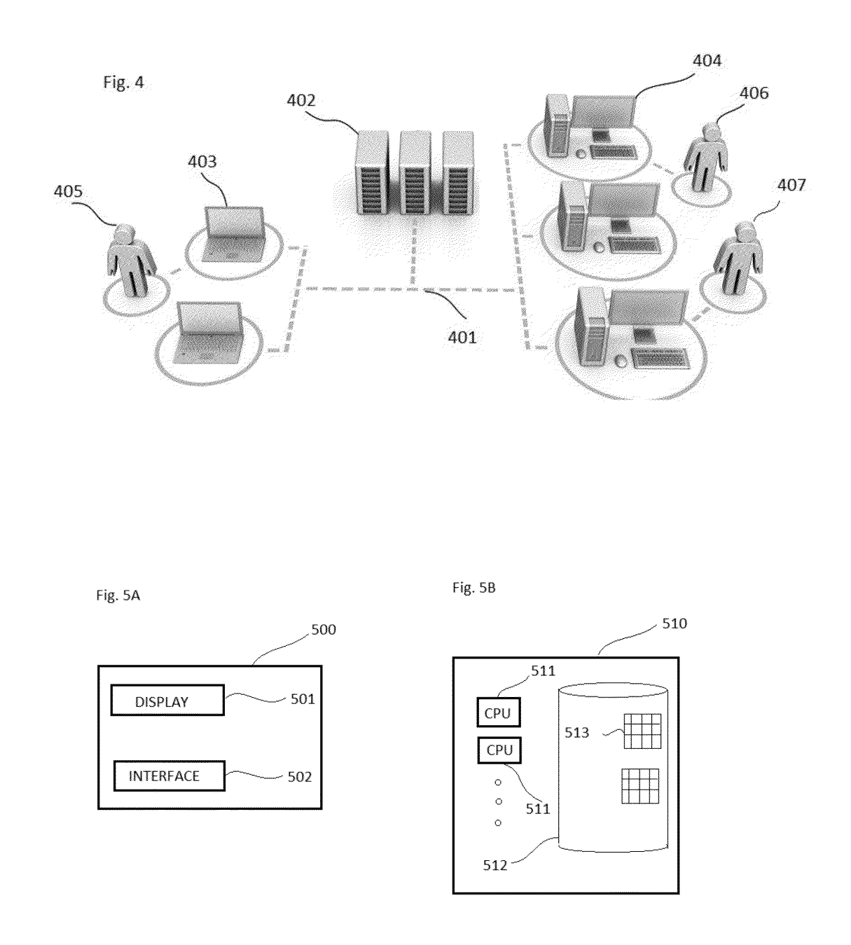

FIG. 4 shows a bit more information pertaining to the hardware involved. Such hardware is currently widespread and well understood and we are bringing it up for the sake of completeness. The method above is meant to run on a computing device such as a computer, server, phone, terminal or other devices. Users such as 405 and 406, through the use of their computing devices or terminals 403 and 404 respectively use the network or internet 401 to connect to one or more servers 402. 401 here could be the currently in-use internet, or a local area network, or a plain telephone system, or a wide area network. For a terminal to connect to the network they can use wired or wireless mediums which may be provisioned with routers and firewalls, but not limited to the above.

A scenario with this architecture would be that user 405 through his use of computing device 403, connects to the server 402 and interfaces with his device to send a message M to user 406. The device in turn relays information over the network 401 and such information is stored on the database of the server. The server then looks through the database for users similar to 406. Let's assume in this case that user 407 was the user who was very similar to 406 and who was found in the database. The server notifies the computing devices of 407, typically through e-mail or instant messaging. 407, through the use of his computing device will then be able to read the profile of user 405, the profile of user 406, as well as the message M, and enter feedback about said message into his terminal. Once 407 is done writing his feedback, he would submit it electronically through the use of the terminal, and that feedback would be sent over the internet back to server 402 and stored into the database. At that point, user 405 would be notified by said server that a review for his message is available, and would be able to view said review using his terminal. If said review was positive in nature, the message M would also be forwarded to user 406 as it was originally intended to do—otherwise, the message would not be forwarded.

FIG. 5A is a diagram showing one embodiment of the terminal used by users. In this embodiment, the terminal 500 comprises a display system 501 as well as an interface 502 that allows its users to interact with it.

FIG. 5B is a diagram showing one embodiment of the server to which the terminals are connecting. The server 510 contains one or more processing units 511, as well as memory 512, which may be made up of one or more databases 513.

The above described the preferred embodiment, but there are several alternate embodiments which are described hereafter.

### Alternative Embodiments

We believe there are several ways to implement the overall system described above. The common factors are that a user on website W wants a simplified way to get his message reviewed by someone before it arrives at his intended recipient.

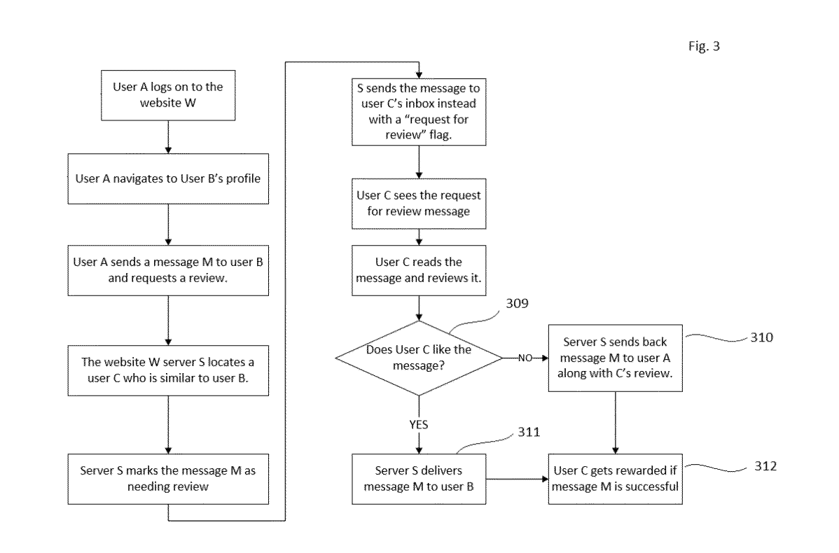

One such embodiment is described in FIG. 3. This embodiment is similar to the one in FIG. 2 except the last few steps.

In particular, if user C does like the message as shown in 309, then the message will be delivered to the original intended recipient user B (as in 311), otherwise if user C does not like the message, the feedback given by user C will be sent back to user A (310). The next step is where the difference is—at this point, user C may be compensated for his efforts. To explain further, user C may be rewarded for submitting his review about user A's message, or he can be rewarded if user A deems user C's review to be above a certain quality or helpfulness threshold. For example, in one embodiment, a user whose message was reviewed can have the option of selecting whether the review was useful, or to grade it on a scale from one to five, and those would serve as thresholds. Such rewards may be purely virtual, such as points on the website, or they may be monetary. For example of a virtual reward, people who have done the highest number of useful message reviews may get a higher ranking in web searches or higher profile placements within the website, or may even redeem the points to get gifts or free website subscription months. By useful reviews here we mean a review that was submitted to user A that user A later accepted as being useful through the website. The review reward could be monetary with user A offering money to website S and website S distributing this money to message reviewers while potentially keeping a commission.

In another embodiment, the server may only select intermediary users (we use intermediary users here to describe a user who is not the intended recipient of the message but who reads it and has the option to review it before said message is sent to its actual intended recipient) who are similar to the target user but also unlikely to actually know the target user. For example, if user A is e-mailing the CEO of a company in the US, a possible intermediate user might be the CEO of an unrelated company in Canada.

In yet another embodiment, a user can require anyone who messages him to have his message undergo a review—for example, highly influential individuals on business networks, or highly desirable individuals on online dating websites might prefer not to waste their time dealing with subpar messages and would prefer to have someone else review their messages first.

In another embodiment, the user may ask for his intermediary reviewer to be geographically distant from his intended user, and then the server would make sure that said intermediary is at least a specified number of miles away.

### CONCLUSIONS, RAMIFICATIONS AND SCOPE

Thus the reader will see that at least one embodiment of the message review system described above will allow users to easily get valuable feedback about their messages from people who are well suited to give such feedback, before said messages are allowed to reach their intended recipients.

While the above description contains many specificities, these should not be construed as limitations on the scope but rather as an exemplification of one or several embodiments thereof. Many other variations are possible. For example, it may be possible for the review requests to be sent on a separate website—i.e. for a messages M sent within a website W, website R can be used to request reviews of M.

Accordingly, the scope should be determined not by the embodiments illustrated, but by the appended claims and their legal equivalents.

What is claimed is:

1. A computer-implemented method comprising:
receiving a plurality of user profiles, each user profile comprising characteristics of a respective user;
receiving a request from a first user to send a message to a second user;
notifying a plurality of different users about said request;
exposing information about said first user's profile, said second user's profile, and said message to said different users;
receiving at least one review from said different users about first user's message;
notifying and providing said first user with said at least one review.

2. The method of claim 1, wherein the notifying steps are done through the use of electronic mail.

3. The method of claim 1, wherein said plurality of notified different users are geographically distant from said first user's location.

4. The method of claim 1, further comprising:
rewarding said plurality of different users based on review quality.

5. The method of claim 1, further comprising:
anonymizing said first user by hiding said first user's personal profile information from said different users.

6. The method of claim 1, further comprising:
anonymizing said plurality of different users by hiding said different users' personal information from said first user.

7. The method of claim 1, further comprising:
allowing said plurality of different users to permanently opt out of providing reviews.

8. A computer-implemented method comprising:
receiving a request from a first user to send a message to a second user;
receiving a request to do a message review, said request being associated with a third user;
revealing said first user's profile information to said third user;
revealing said second user's profile information to said third user;
revealing said message to said third user;
receiving a critique of said first user's message, by said third user;
displaying said critique to said first user.

9. The method of claim 8, wherein the step of revealing is done only if said third user and said second user are geographically distant.

10. The method of claim 8, further comprising:
prompting said first user to grade said critique;
rewarding said third user if said grade is above a threshold.

11. The method of claim 8, further comprising
anonymizing said first user's profile information before revealing it to said second user,
by removing said first user's personal information.

12. The method of claim 8, wherein selecting a third user comprises finding a user that is similar to the second user.

13. A non-transitory computer-readable medium comprising instructions that, when executed by as processor with memory, are configured to at least:
receive a request to send a message from a first user to a second user;
store said request in said memory,
select a plurality of users from said memory,
notify said plurality of users about said request,
display said first user's profile, second user's profile, and said message to said plurality of users,
receive a plurality of user critiques about said message from said plurality of users, and
provide said first user with said plurality of user critiques.

14. The medium of claim 13, where the instructions are further configured to:
anonymize said first user's profile by removing personal information.

15. The medium of claim 13, where the instructions are further configured to:
anonymize said plurality of user critiques.

16. The medium of claim 13, where the instructions are further configured to:
verify said plurality of users is geographically distant from said second user and from
said first user.

17. The medium of claim 13, where the instructions are further configured to:
provide a reward said plurality of users.

18. The medium of claim 13, wherein notifying the plurality of users gets done by electronic mail.
